(19) United States
(12) Patent Application Publication
(10) Pub. No.: US 2025/0229799 A1
(43) Pub. Date: Jul. 17, 2025

(54) DATA MANAGEMENT DEVICE, DATA MANAGEMENT METHOD, AND DATA MANAGEMENT PROGRAM

(71) Applicant: DENSO CORPORATION, Kariya-city (JP)

(72) Inventor: Ryota SAITO, Kariya-city (JP)

(21) Appl. No.: 19/069,822

(22) Filed: Mar. 4, 2025

Related U.S. Application Data
(63) Continuation of application No. PCT/JP2023/031928, filed on Aug. 31, 2023.

(30) Foreign Application Priority Data
Sep. 12, 2022 (JP) 2022-144634

(51) Int. Cl. B60W 60/00

(52) U.S. Cl. CPC B60W 60/00; B60W 2556/65

(57) ABSTRACT

A data management device, a data management device, a data management method, a non-transitory tangible storage medium storing a data management program, or a data management system receives a data request, collects vehicle data transmitted from at least one device mounted on a vehicle, standardizes the collected vehicle data to generate standard data, compares the received data request with the generated standard data to detect data that is insufficient for the data request, and supplements the insufficient data using different vehicle data.

### CROSS REFERENCE TO RELATED APPLICATIONS

The present application is a continuation application of International Patent Application No. PCT/JP2023/031928 filed on Aug. 31, 2023, which designated the U.S. and claims the benefit of priority from Japanese Patent Application No. 2022-144634 filed on Sep. 12, 2022. The entire disclosures of all of the above applications are incorporated herein by reference.

### TECHNICAL FIELD

The present disclosure relates to a technology for supplementing insufficient data.

### BACKGROUND

A simulation system of a comparative example generates a data model of an autonomous vehicle and simulates the response of the autonomous vehicle to a simulated dynamic object.

### SUMMARY

A data management device, a data management device, a data management method, a non-transitory tangible storage medium storing a data management program, or a data management system receives a data request, collects vehicle data transmitted from at least one device mounted on a vehicle, standardizes the collected vehicle data to generate standard data, compares the received data request with the generated standard data to detect data that is insufficient for the data request, and supplements the insufficient data using different vehicle data.

### BRIEF DESCRIPTION OF THE DRAWINGS

FIG. 1 is a block diagram showing a physical configuration of a vehicle network system.

FIG. 2 is a block diagram showing a functional configuration of the vehicle network system.

FIG. 3A is a block diagram showing a hardware configuration of a first ECU in the vehicle network system.

FIG. 3B shows a hardware configuration of second to sixth ECUs in the vehicle network system.

FIG. 4 is a diagram showing a hardware configuration of a server device in the vehicle network system.

FIG. 5 is a diagram showing an example of a data model according to the embodiment.

FIG. 6 is a sequence diagram showing a process in which the first and second ECUs supplement insufficient data in the vehicle network system.

### DETAILED DESCRIPTION

A data model generated by the simulation system of the comparative example is a data model for executing a single application program, and is therefore poor in versatility. It is difficult to apply the data model to multiple vehicle types or vehicle models as is. Furthermore, even when the data model can be applied to multiple vehicle types or vehicle models, differences in in-vehicle devices may result in the insufficiency of data for some vehicle types or vehicle models. As a result of detailed study by the inventor, it has been found that it may be difficult for application execution devices to execute the same application program on multiple vehicle types or models.

It is also conceivable that various service providers, including third parties, will develop application programs and provide services to users. However, as a result of detailed consideration by the inventor, it has been found that it is difficult for various service providers to develop application programs taking into account the differences between vehicle types and models. It is therefore desirable for the execution device to run the same application program on multiple vehicle types or vehicle models.

It is desirable to supplement insufficient data when data required for execution of an application program is insufficient in one example embodiment of the present disclosure.

A data management device according to one example embodiment of the present disclosure is a device for a vehicle, and includes a request reception unit, a data collection unit, an insufficiency detection unit, and a supplement unit. The request reception unit is configured to receive a data request from an application execution unit that executes an application program. The data collection unit is configured to collect vehicle data transmitted from at least one device mounted on the vehicle, and standardize the collected vehicle data to generate standard data. The insufficiency detection unit is configured to compare the data request received by the request reception unit with the standard data generated by the data collection unit to detect insufficient data that is insufficient from the data request. The supplement unit is configured to supplement the insufficient data detected by the insufficiency detection unit using different vehicle data that is the standard data of at least one different vehicle different from the vehicle.

The data management device according to one example embodiment of the present disclosure is possible to supplement data required for executing an application program using different vehicle data when the data is insufficient. Furthermore, the application execution unit can execute various application programs using the data supplemented by the data management device, regardless of the type and model of the vehicle in which it is installed.

A data management method according to another example embodiment of the present disclosure is executed by a processing device, and includes: receiving a data request from an application execution unit configured to execute an application program; collecting vehicle data transmitted from at least one device mounted on a vehicle; standardizing the collected vehicle data to generate standard data; comparing the received data request with the generated standard data to detect data that is insufficient for the data request; and supplementing the insufficient data using different vehicle data that is the standard data of at least one different vehicle different from the vehicle.

According to the data management method, the similar effects as those of the data management device are achieved.

A data management program according to another example embodiment of the present disclosure causes a processing device to: receive a data request from an application execution unit configured to execute an application program; collect vehicle data transmitted from at least one device installed in the vehicle; standardize the collected vehicle data to generate standard data; compare the received data request with the generated standard data; detect insufficient data that is insufficient from the data request; and supplement the insufficient data using different vehicle data that is the standard data of at least one different vehicle different from the vehicle.

When the data management program is executed by the processing device, the similar effects as those of the data management device are achieved.

A data management system according to another example embodiment of the present disclosure includes: an electronic control unit mounted on a vehicle; and a server device. The server device includes a server storage, a server controller, and a server communication unit. The server storage stores standard data obtained by standardizing a plurality of vehicle data received from each vehicle. The server controller is configured to select the standard data from the server storage. The server communication unit is configured to communicate with the vehicle and transmit the standard data selected by the server controller to the vehicle. The electronic control unit includes a request reception unit, a data collection unit, an insufficiency detection unit, a vehicle communication unit, and a supplement unit. The request reception unit is configured to receive a data request from an application execution unit that executes an application program. The data collection unit is configured to collect vehicle data transmitted from at least one device mounted on the vehicle, and standardize the collected vehicle data to generate standard data. The insufficiency detection unit is configured to compare the data request received by the request reception unit with the standard data generated by the data collection unit to detect insufficient data that is insufficient from the data request. The vehicle communication unit is configured to receive different vehicle data that is the standard data of at least one different vehicle different from the vehicle, and is transmitted from the server communication unit. The supplement unit is configured to supplement the insufficient data detected by the insufficiency detection unit using the different vehicle data received by the vehicle communication unit.

The data management system according to one example embodiment of the present disclosure can supplement data necessary for executing the application program by using the different vehicle data received from the server device when the electronic control unit does not have the data necessary for executing the application program. Furthermore, the electronic control unit can execute various application programs using the supplement data, regardless of the type and model of the vehicle in which it is installed.

### 1. Configuration

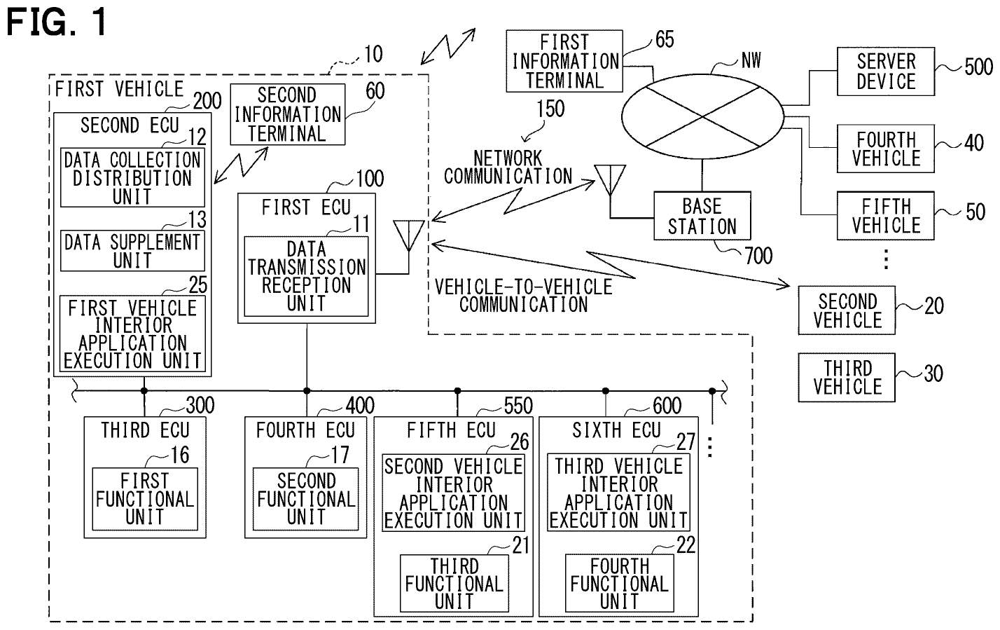

A configuration of a vehicle network system 150 according to the present embodiment will be described with reference to FIGS. 1 to 4.

The vehicle network system 150 includes a server device 500, a first vehicle 10, a second vehicle 20, a third vehicle 30, a fourth vehicle 40, a fifth vehicle 50, a first information terminal 65, and a base station 700. In detail, the vehicle network system 150 includes the server device 500, multiple electronic control units (hereinafter, ECUs) mounted on each of the first to fifth vehicles 10 to 50, the first information terminal 65, and the base station 700. The first information terminal 65 is a PC, a tablet terminal, a smartphone, a wearable device, or the like. In the present embodiment, the vehicle network system 150 includes five vehicles, but may include four or fewer vehicles, or may include six or more vehicles.

The server device 500, the fourth vehicle 40, the fifth vehicle 50, the first information terminal 65, and the base station 700 are connected to a wide area communication network NW. The server device 500 performs network communication with the fourth vehicle 40, the fifth vehicle 50 and the first information terminal 65 via the wide area communication network NW. The first to third vehicles 10 to 30 are wirelessly connected to the server device 500, the fourth vehicle 40, the fifth vehicle 50, and the first information terminal 65 via the base station 700, and perform network communication with the server device 500, the fourth vehicle 40, the fifth vehicle 50, and the first information terminal 65. Moreover, the first to third vehicles 10 to 30 are located close to each other. The first to third vehicles 10 to 30 are directly wirelessly connected to each other and perform vehicle-to-vehicle communication with each other.

As shown in FIG. 1, the first vehicle 10 includes a first ECU 100, a second ECU 200, a third ECU 300, a fourth ECU 400, a fifth ECU 550, and a sixth ECU 600. Each of the first to sixth ECUs 100 to 600 is connected to the in-vehicle network. The number of ECUs provided in the first vehicle 10 is not limited to six, but may be five or less, or seven or more. Although not shown in FIG. 1, the second vehicle 20, the third vehicle 30, the fourth vehicle 40, and the fifth vehicle 50 are also equipped with multiple ECUs, similar to the first vehicle 10.

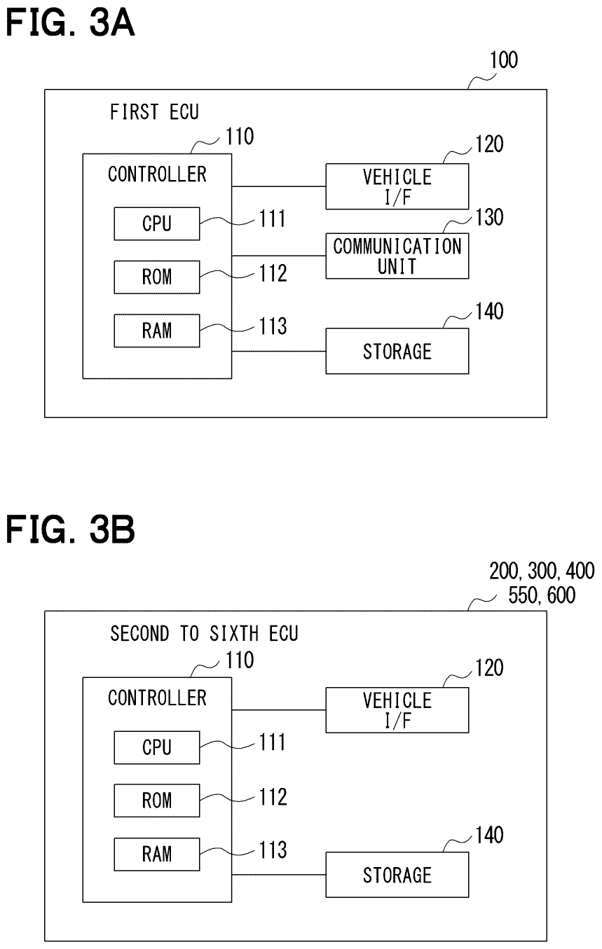

As shown in FIG. 3A, the first ECU 100 includes a controller 110, a vehicle I/F 120, a storage 140, and a communication unit 130. As shown in FIG. 3B, the second to sixth ECUs 200 to 600 each include the controller 110, the vehicle I/F 120, and the storage 140. That is, only the first ECU 100 has the communication unit 130. W

The controller 110 includes a CPU 111, a ROM 112 and a RAM 113. Various functions of the controller 110 are implemented by the CPU 111 executing a program stored in a non-transitory tangible storage medium. In the present embodiment, the ROM 112 corresponds to a non-transitory tangible storage medium storing programs. Further, by executing this program, a method corresponding to the program is executed.

The vehicle I/F 120 is connected to various in-vehicle devices including other ECUs via the in-vehicle network or the like, and acquires various pieces of information from the in-vehicle devices. The in-vehicle network may include CAN and Ethernet. The CAN is an abbreviation for Controller Area Network. The CAN is a registered trademark. The Ethernet is a registered trademark. The in-vehicle devices connected to the vehicle I/F 120 may include a retrofitted exterior device in addition to devices originally mounted on the vehicle.

The communication unit 130 transmits and receives data to and from the server device 500, the first information terminal 65, the fourth vehicle 40, and the fifth vehicle 50 via the wide area communication network NW by wireless communication. In addition, the communication unit 130 transmits and receives data to and from the second vehicle 20 and the third vehicle 30 via vehicle-to-vehicle communication. The communication unit 130, together with the controller 110, implements functions of a data transmission reception unit 11 described later.

The storage 140 includes a first database (hereinafter, DB) 18, a second DB 19, a third DB 14, and a fourth DB 15. The storage 140 stores the vehicle data acquired via the vehicle I/F 120, the data model generated by the first vehicle 10, and the data model acquired via the communication unit 130. The data model is standard data generated by standardizing vehicle data, and will be described in detail later.

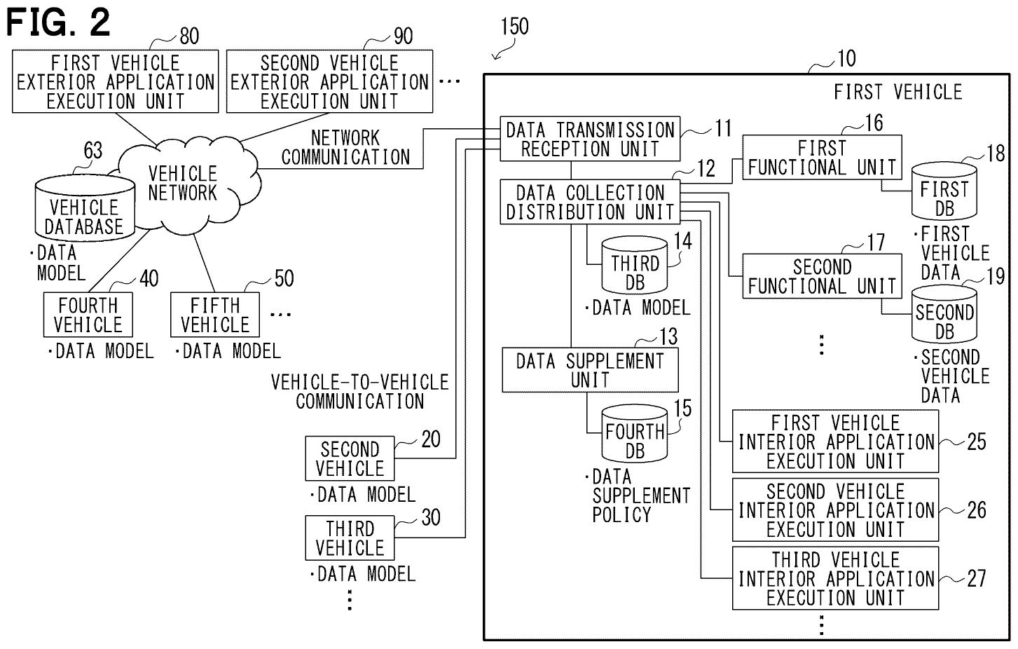

As shown in FIG. 2, the first to sixth ECUs 100 to 600 collectively have the functions of the data transmission reception unit 11, a data collection distribution unit 12, a data supplement unit 13, a first functional unit 16, a second functional unit 17, a third functional unit 21, a fourth functional unit 22, a first vehicle interior application execution unit 25, a second vehicle interior application execution unit 26, and a third vehicle interior application execution unit 27. As shown in FIG. 1, in the present embodiment, the first ECU 100 has a function of the data transmission reception unit 11. The second ECU 200 has the functions of the data collection distribution unit 12, the data supplement unit 13, and the first vehicle interior application execution unit 25. The third ECU 300 has the functions of the first functional unit 16. The fourth ECU 400 has the functions of the second functional unit 17. The fifth ECU 550 has the functions of the second vehicle interior application execution unit 26 and the third functional unit 21. The sixth ECU 600 has the functions of the third vehicle interior application execution unit 27 and the fourth functional unit 22. The various functions described above may be allocated in any manner to the first to sixth ECUs 100 to 600, and all of the functions may be allocated to five or fewer ECUs. In the present embodiment, the second ECU corresponds to the central ECU.

The first functional unit 16 implements a first function to generate first vehicle data and store the generated first vehicle data in the first DB 18. The first function is, for example, a function of acquiring the current position of the vehicle, and the first vehicle data is, for example, raw data indicating the current position acquired from a GPS.

The second functional unit 17 implements a second function to generate second vehicle data and store the generated second vehicle data in the second DB 19. The second function is, for example, a vehicle interior information acquisition function, and the second vehicle data is, for example, raw data indicating the outside air temperature acquired from an outside air temperature sensor. Similarly, the third functional unit 21 implements a third function, to generate third vehicle data and store the generated third vehicle data in a fifth DB (not shown). The fourth functional unit 22 implements a fourth function to generate fourth vehicle data and store the fourth vehicle data in a sixth DB (not shown).

The first vehicle interior application execution unit 25 executes a first vehicle interior application program based on a data model stored in the third DB 14 described later. The second vehicle interior application execution unit 26 executes the second vehicle interior application program based on the data model stored in the third DB 14. The third vehicle interior application execution unit 27 executes a third vehicle interior application program based on the data model stored in the third DB 14. The first, second and third vehicle interior application programs are programs for providing services to end users, and are developed and provided by a service provider. The end user may be a vehicle user, a vehicle owner, an operation manager, or the like. The provided services include fleet services, car sharing services, and the like.

The data collection distribution unit 12 acquires the first, second, third and fourth vehicle data from the first and second DBs 18, 19 and the fifth and sixth DBs. Then, the data collection distribution unit 12 converts the acquired first, second, third, and fourth vehicle data into the standard format, associates the data with a hierarchical classification, and stores the data in the third DB 14. The vehicle data that has been standardized in this manner corresponds to a data model. The “data value” is normalized so that the same physical quantity is represented in the same unit regardless of the vehicle manufacturer, vehicle type, vehicle model. In other words, the data model is data structured in a common format so that it can be commonly handled regardless of differences in vehicle manufacturers, vehicle types, and vehicle models.

FIG. 5 shows an example of the data model. The data model includes items such as “vehicle specifications”, “position information”, “in-vehicle interior information”, and “environment recognition” as items set in the top, first layer. Each item belonging to the first layer represents a category of the vehicle data.

Furthermore, the “vehicle specifications” of the first layer item is a category indicating the vehicle model, equipment, and the like, and the second layer item includes “vehicle identification signal”, “model name”, and “manufacturer.” The “position information” of the first layer item is a category indicating information related to the vehicle position, and the second layer items includes “current position”, “speed”, and “direction”. The “vehicle interior information” of the first layer item is a category indicating the vehicle interior state, and the second layer item includes “A/C state”, “outside air temperature”, and “seat sensor state”. The “environmental recognition” of the first layer item is a category indicating the environment outside the vehicle, and the second layer item includes “signs”, “white lines”, and “obstacles”. Each item in the second layer may further have a third layer below it.

The application programs executed by the first, second, and third vehicle interior application execution units 25, 26, and 27 are developed and provided not only by the vehicle manufacturer but also by third parties. It is difficult for the third party to develop an application program for a vehicle for each type and model of vehicle. Therefore, the platform on the vehicle network system 150 specifies that application programs for vehicles operate based on the standardized data model, and provides a development environment that makes it easy for various suppliers, including the third party, to develop application programs.

When the data model necessary to execute the application program by the first, second or third vehicle interior application execution unit 25, 26, 27 is insufficient, the data supplement unit 13 detects the insufficient data and supplements the insufficient data using a data model of another vehicle (hereinafter referred to as different vehicle data). The data supplement unit 13 supplements the insufficient data based on a data supplement policy stored in the fourth DB 15. The data supplement policy indicates a method for supplementing insufficient data. More specifically, the data supplement policy describes communication means to be selected from network communication and vehicle-to-vehicle communication in order to acquire the data model. Further, the data supplement policy also describes alternative means to be selected when network communication and vehicle-to-vehicle communication are not possible, or when there is no different vehicle data model that corresponds to the insufficient data.

The data transmission reception unit 11 receives data models of other vehicles through network communication or vehicle-to-vehicle communication via the communication unit 130. In addition, the data transmission reception unit 11 transmits the data model generated by the data collection distribution unit 12 to the different vehicle or the server device 500 by network communication or vehicle-to-vehicle communication via the communication unit 130.

The first to sixth ECUs 100 to 600 are connected to a second information terminal 60 wirelessly or via a wire to perform data communication. The second information terminal 60 is, for example, a mobile terminal such as a smartphone, a tablet, or a wearable device that the user brings into the vehicle.

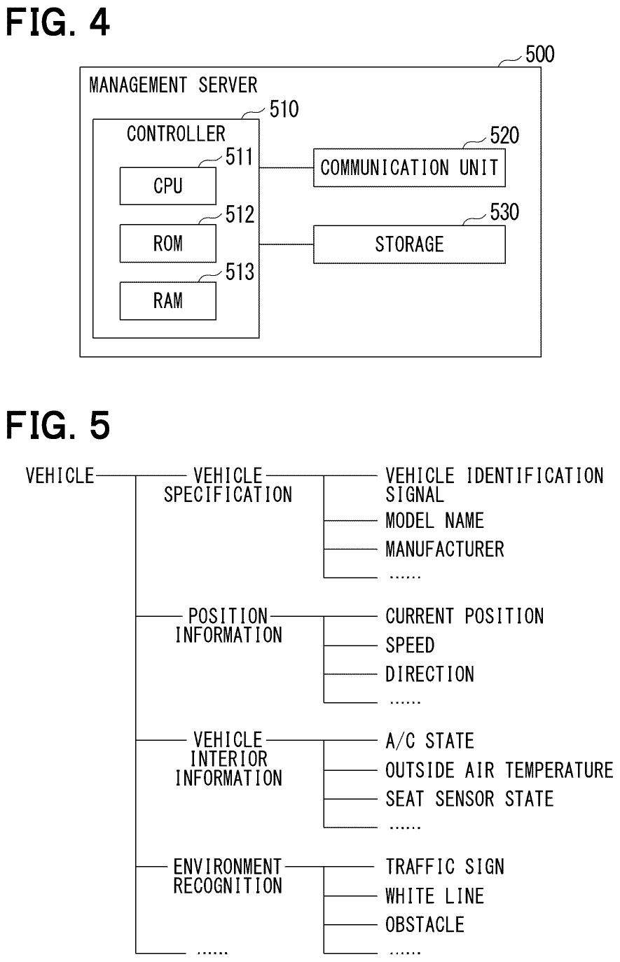

As shown in FIG. 4, the server device 500 includes a controller 510, a communication unit 520, and a storage 530.

The controller 510 includes a CPU 511, a ROM 512 and a RAM 513. Various functions of the controller 510 are implemented by the CPU 511 executing a program stored in a non-transitory tangible storage medium. In this example, the ROM 512 corresponds to a non-transitory tangible storage medium storing programs. Further, by executing this program, a method corresponding to the program is executed.

The communication unit 520 transmits and receives data to and from the first to fifth vehicles 10 to 50 (specifically, the ECU of each vehicle) via the wide area communication network NW.

As shown in FIG. 2, the controller 510 has the functions of a first vehicle exterior application execution unit 80 and a second vehicle exterior application execution unit 90. The first vehicle exterior application execution unit 80 executes the first vehicle exterior application program based on a data model described later. The second vehicle exterior application execution unit 90 executes a second vehicle exterior application program based on the data model. The first and second vehicle exterior application programs are programs for providing services to end users, and are developed and provided by a service provider.

The first, second, and third vehicle interior application programs and the first and second vehicle exterior application programs are, for example, a fuel prediction application program and an automatic platooning application program. The first, second, and third vehicle interior application execution units 25, 26, and 27 and the first and second vehicle exterior application execution units 80 and 90 execute the fuel prediction application program to predict the fuel consumption of the first vehicle 10 up to the destination. In addition, the first, second, and third vehicle interior application execution units 25, 26, and 27 and the first and second vehicle exterior application execution units 80, 90 execute the automatic platooning application program to cause the first vehicle 10 to travel in a platoon in automated driving to the destination.

The storage 530 includes a vehicle DB 63. The vehicle DB 63 stores the data models collected from the first to fifth vehicles 10 to 50.

### 2. Process

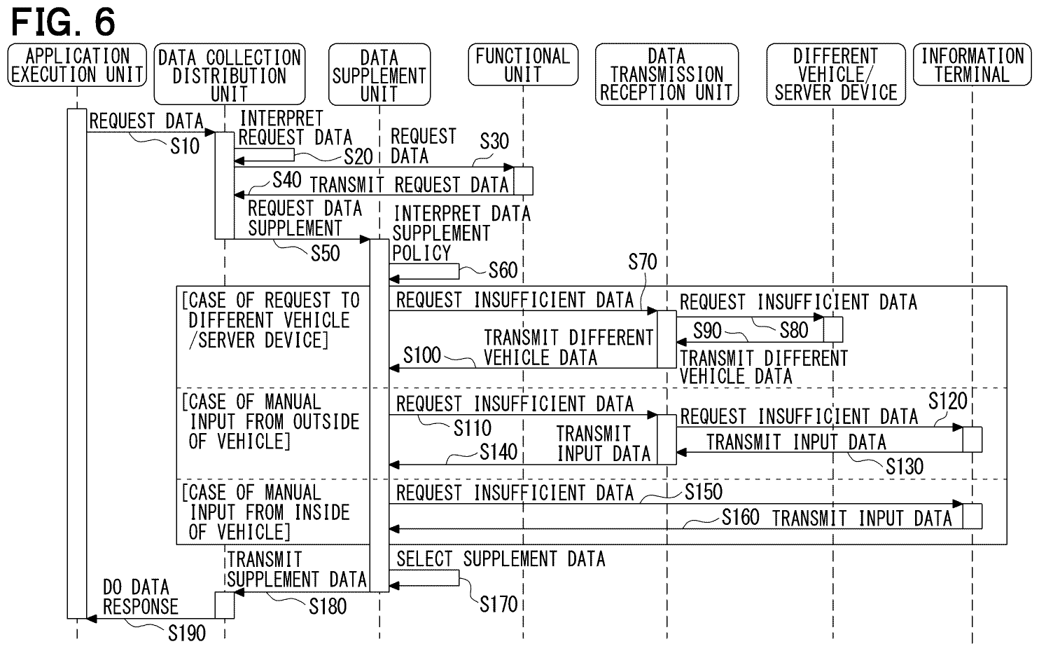

Next, the operation of the first ECU 100 and the second ECU 200 in the process of supplementing the insufficient data will be described with reference to a sequence diagram of FIG. 6. In the present embodiment, the first ECU 100 and the second ECU 200 correspond to a data management device of the present disclosure.

In S10, any one of the first, second, and third vehicle interior application execution units 25, 26, and 27 requests the data collection distribution unit 12 to provide the data model required for executing the application program.

For example, when the first, second or third vehicle interior application execution unit 25, 26, 27 is executing a fuel efficiency prediction application program, the first, second or third vehicle interior application execution unit 25, 26, 27 requests the distance to the destination, the speed, the number of occupants, whether the air conditioning is on or off, and the outside temperature as the data model. The distance to the destination is calculated from the GPS signal. The speed is calculated from a detection signal of a vehicle speed sensor. The number of occupants is calculated from the detection signal of the seat sensor or the image of the interior camera. Whether the air conditioning is on or off is calculated from the air conditioning control signal. The outside air temperature is calculated from a detection signal of an outside air sensor. The fuel economy prediction application calculates the fuel economy at the time of traveling to a destination based on the distance, speed, number of passengers, whether the air conditioning is on or off, outside temperature, and the like obtained as the data model.

In addition, when the first, second or third vehicle interior application execution unit 25, 26, 27 is executing an automated platooning application program, the first, second or third vehicle interior application execution unit 25, 26, 27 requests the current position, the position and content of signs, the position of white lines, and the position of obstacles as a data model. The current position is calculated from the GPS signal. The position and content of the sign and the position of the white line are calculated from the results of image recognition based on the images captured by the peripheral cameras. The position of the obstacle is calculated from the results of the image recognition or from observations by sonar or lidar. The automated platooning application controls the automated driving of the platooning using the current position, information on the peripheral environment, and map information acquired as the data model.

In S20, the data collection distribution unit 12 interprets the received data request and recognizes the type of vehicle data to be acquired from the first functional unit 16 and the second functional unit 17.

In S30, the data collection distribution unit 12 requests the first functional unit 16, the second functional unit 17, the third functional unit 21, and the fourth functional unit 22 for vehicle data of the type recognized in S20.

In S40, the first functional unit 16 and the second functional unit 17 acquire the requested vehicle data from the first DB 18 and the second DB 19, and transmit the data to the data collection distribution unit 12. The third functional unit 21 and the fourth functional unit 22 acquire the requested vehicle data from the fifth DB and the sixth DB, and transmit the data to the data collection distribution unit 12. The first DB 18, the second DB 19, the fifth DB and the sixth DB may not store all of the requested vehicle data.

The in-vehicle devices mounted on a vehicle vary depending on the type or model of the vehicle. Therefore, there are cases where the first vehicle 10 does not have an in-vehicle device for acquiring the requested vehicle data. In such a case, the first DB 18, the second DB 19, the fifth DB and the sixth DB do not store the requested vehicle data. For example, there are vehicle models equipped with an outside air sensor and vehicle models that are not equipped with the outside air sensor. When the first vehicle 10 is not equipped with the outside air sensor, the first DB 18, the second DB 19, the fifth DB and the sixth DB do not store vehicle data on the outside air temperature. In addition, there are vehicle types that are equipped with peripheral cameras and vehicle types that are not equipped with the peripheral cameras. For example, in the platooning, the leading vehicle may be equipped with the peripheral camera, but the following vehicles may not be equipped with the peripheral cameras. When the first vehicle 10 is not equipped with the peripheral camera, the first DB 18, the second DB 19, the fifth DB and the sixth DB do not store vehicle data of captured images.

Furthermore, even when the first vehicle 10 is equipped with the in-vehicle device that acquires the requested vehicle data, the in-vehicle device may be unable to acquire the vehicle data due to an abnormality or the like in the in-vehicle device. In such a case, the first DB 18, the second DB 19, the fifth DB and the sixth DB do not store some or all of the requested vehicle data.

When the first DB 18 and the second DB 19 do not store all of the requested vehicle data, the first functional unit 16 and the second functional unit 17 transmit, to the data collection distribution unit 12, the vehicle data stored in the first DB 18 and the second DB 19 among the requested vehicle data.

In S50, the data collection distribution unit 12 standardizes the received vehicle data to generate the data model. Then, the data collection distribution unit 12 compares the data models requested by the first, second, and third vehicle interior application execution units 25, 26, and 27 with the generated data models, and detects any data models that are insufficient from the requested data models (hereinafter, “insufficient data”). The data collection distribution unit 12 requests the data supplement unit 13 to supplement the insufficient data. In addition, the data collection distribution unit 12 may periodically acquire vehicle data from the first functional unit 16, the second functional unit 17, the third functional unit 21, and the fourth functional unit 22, regardless of data requests from the first, second, and third vehicle interior application execution units 25, 26, and 27, and standardize the acquired vehicle data to generate the data model.

In S60, the data supplement unit 13 refers to the data supplement policy stored in the fourth DB 15 to determine the data supplement means. In detail, the data supplement policy specifies, for each type of insufficient data, (i) a method for selecting and calculating the supplement data when there are multiple candidates for supplement data to supplement the insufficient data, (ii) a means for acquiring different vehicle data when communication is possible, and (iii) an alternative means when communication is not possible.

The data supplement policy specifies that, for the above (i), from among multiple candidates, (ia) other vehicle data of another vehicle having an environment closest to that of the first vehicle 10 is selected, or (ib) a statistical value obtained by statistically calculating the multiple candidates is selected. The environment here includes (A) the environment in which the first vehicle 10 exists, and (B) the state of the first vehicle 10 itself. Examples of (A) include weather, outside temperature, current position, prefecture, expressway, general road, mountain road, and the like. Examples of (B) include the vehicle type, vehicle model, power supply state (specifically, ignition on or off), driving state (for example, driving or stopped), number of occupants, driving state (for example, automated driving or manual driving), and the like.

Regarding (ii) described above, the data supplement policy specifies that insufficient data that depends on distance is acquired through vehicle-to-vehicle communication, and insufficient data that depends on the type or model of the vehicle is acquired through network communication.

The targets of the inter-vehicle communication are the second vehicle 20 and the third vehicle 30 that are located close to the first vehicle 10. On the other hand, the targets of the network communication are the fourth vehicle 40 and the fifth vehicle 50 that are located far away from the first vehicle 10, or the server device 500. Therefore, the data supplement policy associates insufficient data that is highly dependent on distance with vehicle-to-vehicle communication, and associates insufficient data that is highly dependent on the vehicle type or model with network communication.

The insufficient data that is highly dependent on distance is, for example, information on the environment (A) such as weather, outside temperature, and current position. The data supplement unit 13 acquires the different vehicle data acquired through vehicle-to-vehicle communication in order to supplement insufficient data that depends on distance. An example of the insufficient data that is highly dependent on the vehicle type or model is vehicle information. The vehicle information includes vehicle control data, vehicle coolant noise, and the like. The data supplement unit 13 acquires other vehicle data acquired through network communication in order to supplement the insufficient data that depends on the vehicle type or vehicle model.

In addition, with regard to (iii) described above, the data supplement policy specifies a substitute means for obtaining insufficient data in cases where both network communication and vehicle-to-vehicle communication are not possible or where the data model of another vehicle corresponding to the insufficient data does not exist. When either the network communication or vehicle-to-vehicle communication is possible, the data supplement unit 13 acquires the insufficient data using the possible communication, regardless of the communication means specified by the data supplement policy.

The substitute means include manual entry of user-set values by the user, and automatic entry of fixed or calculated values. The user manually inputs the user setting values via the first information terminal 65 or the second information terminal 60.

When the user is in the first vehicle 10, the user manually inputs the user setting values via the second information terminal 60, and when the user is performing operation management, or the like at a location away from the first vehicle 10, the user manually inputs the user setting values via the first information terminal 65.

The fixed value is a default value that is set in advance. The calculated value includes a previous value, a statistical value, and an estimated value, and is used when the temporary data insufficiency occurs. The previous value is a data model acquired in the previous processing cycle that corresponds to the insufficient data in the current processing cycle. The statistical value is the average value, median value, or mode value of the data model acquired during a predetermined period in the past that corresponds to the insufficient data in the current processing cycle. The estimated value is a value estimated from a data model acquired during a predetermined period in the past, which corresponds to the insufficient data in the current processing cycle.

In the following, when the communication is possible, the processes of S70 to S100 are executed. When the communication is not possible and the manual input is performed by the user from outside the vehicle via the first information terminal 65, the processes in S110 to S140 are executed. When the communication is not possible and the manual input is performed by the user from inside the vehicle via the second information terminal 60, the processes in S150 and S160 are executed.

In S70, the data supplement unit 13 requests the insufficient data from the data transmission reception unit 11 along with the selected communication means. The data supplement unit 13 may request, as the insufficient data, the different vehicle data of different vehicles of a specific manufacturer or types and/or different vehicles in the periphery of the current position of the first vehicle 10.

In S80, when the selected communication means is network communication, the data transmission reception unit 11 transmits the identification number of the first vehicle 10 and requests the insufficient data from the server device 500, the fourth vehicle 40, and the fifth vehicle 50 via network communication. The data transmission reception unit 11 may transmit the current position of the first vehicle 10 together with the identification number of the first vehicle 10 to the server device 500, the fourth vehicle 40 and the fifth vehicle 50 via network communication.

Next, in S90, the server device 500 transmits the different vehicle data, which is a data model corresponding to the insufficient data, from the vehicle DB 63 to the data transmission reception unit 11 via network communication. Based on the identification number of the first vehicle 10, the server device 500 may select the different vehicle data of the different vehicle of the same manufacturer or model as the first vehicle 10 from the different vehicle data stored in the vehicle DB 63, and transmit the selected different vehicle data to the data transmission reception unit 11. In addition, the server device 500 selects the different vehicle data of the different vehicles that are present within a predetermined range from the current position of the first vehicle 10 (or at a position closest to the first vehicle 10) from the different vehicle data stored in the vehicle DB 63 based on the current position of the first vehicle 10, and transmit the selected different vehicle data to the data transmission reception unit 11. In addition, the server device 500 selects, from the different vehicle data stored in the vehicle DB 63, different vehicle data of the different vehicle that is made by the same manufacturer as the first vehicle 10 or of the same model as the first vehicle 10 and is within a predetermined range from the current position of the first vehicle 10 (or the position closest to the first vehicle 10), and transmit the selected different vehicle data to the data transmission reception unit 11. Furthermore, the fourth vehicle 40 and the fifth vehicle 50 transmit the different vehicle data to the data transmission reception unit 11.

In S80, when the selected communication means is vehicle-to-vehicle communication, the data transmission reception unit 11 requests the insufficient data from the second vehicle 20 and the third vehicle 30 via vehicle-to-vehicle communication. At this time, the data transmission reception unit 11 presents a predetermined condition and requests the insufficient data that satisfies the predetermined condition. Specifically, in the case where the insufficient data is a data model that depends on the vehicle model, such as a predicted water temperature value or a predicted remaining charge value, the predetermined condition is that the different vehicle is a vehicle of a specific manufacturer or a specific vehicle model. In addition, when the insufficient data is a data model that depends on location, such as the outside temperature, weather, and the like, the predetermined condition is that the current position of the different vehicle is within a predetermined range centered on the current position of the first vehicle 10, or that the ID of the traveling road of the different vehicle matches the ID of the traveling road of the first vehicle 10. Next, in S90, the second vehicle 20 and the third vehicle 30 transmit the different vehicle data to the data transmission reception unit 11 via vehicle-to-vehicle communication.

In S100, the data transmission reception unit 11 transmits the received different vehicle data to the data supplement unit 13.

Also, in S110, the data supplement unit 13 requests the data transmission reception unit 11 to manually input the insufficient data by the user outside the vehicle.

In S120, the data transmission reception unit 11 requests the first information terminal 65 to manually input the insufficient data via the communication network.

In S130, the first information terminal 65 transmits the input data manually input by the user to the data transmission reception unit 11.

In S140, the data transmission reception unit 11 transmits the input data to the data supplement unit 13.

Also, in S150, the data supplement unit 13 requests the second information terminal 60, via vehicle interior communication, to manually input the insufficient data by the user inside the vehicle. The vehicle interior communication may be wired communication, infrared communication, Bluetooth (registered trademark) communication, or the like.

In S160, the second information terminal 60 transmits the input data manually input by the user to the data supplement unit 13.

In S170, the data supplement unit 13 selects supplement data for supplementing the insufficient data from the received different vehicle data or input data. When there are multiple candidates for supplement data and the above-described (i) of the data supplement policy specifies that (ia) the different vehicle data of the different vehicle having an environment most similar to that of the first vehicle 10 is selected, the data supplement unit 13 selects the different vehicle data of the different vehicle having the environment most similar to that of the first vehicle 10 from the multiple candidates. The environment here includes the above-described environments (A) and (B). Furthermore, even when the data supplement unit 13 receives the different vehicle data selected by the server device 500, the data supplement unit 13 selects the different vehicle data to be used for supplement from the received different vehicle data based on the data supplement policy.

In other words, when the data supplement unit 13 receives the different vehicle data from each of the vehicle DB 63, the fourth vehicle 40 and the fifth vehicle 50, it selects, from the three different vehicle data, the different vehicle data acquired in the environment that is closest to the current environment of the first vehicle 10 as the supplement data.

In addition, when there are multiple candidates for supplement data and the above-described (i) of the data supplement policy specifies that (ib) a statistical value obtained by statistically calculating the multiple candidates is selected, the data supplement unit 13 selects a statistical value obtained by statistically calculating the multiple candidates. The statistical values include the mean, median, mode, and the like. When the data supplement unit 13 receives the different vehicle data from the vehicle DB 63, the fourth vehicle 40, and the fifth vehicle 50, it calculates statistical values of the three different vehicle data and selects the statistical values as supplement data. Even when the data supplement unit 13 receives the different vehicle data selected by the server device 500, the data supplement unit 13 calculates statistical values based on the data supplement policy, and uses the calculated statistical values for supplement.

In S180, the data supplement unit 13 transmits the selected supplement data to the data collection distribution unit 12.

In S190, the data collection distribution unit 12 generates supplemented data by adding the received supplement data to the generated data model, and transmits the supplemented data to the first, second, or third vehicle interior application execution unit 25, 26, or 27. As a result, even when the first vehicle 10 is not equipped with the outside air sensor, the first, second or third vehicle interior application execution unit 25, 26, 27 can execute the fuel prediction application program using the outside air temperature detected by different vehicles near the first vehicle 10. Furthermore, even when the first vehicle 10 is not equipped with a peripheral camera, the first, second or third vehicle application execution unit 25, 26, 27 can execute the automated platooning application program using the position and content of signs, the position of white lines, and the position of obstacles detected by the vehicle near the first vehicle 10 (for example, the leading vehicle). In the present embodiment, the data collection distribution unit 12 corresponds to a data collection unit, a request reception unit, and an insufficient state detection unit of the present disclosure, and the data supplement unit 13 corresponds to a supplement unit.

### 3. Effects

According to the present embodiment described in detail above, the following effects are obtained.

(1) When the data model required for the execution of an application program by the first vehicle interior application execution unit 25 or the second vehicle interior application execution unit 26 is insufficient, the first ECU 100 and the second ECU 200 can supplement the insufficient data using the different vehicle data or input data. Furthermore, the first vehicle interior application execution unit 25 and the second vehicle interior application execution unit 26 can execute various application programs using the data model supplemented by the first ECU 100 and the second ECU 200, regardless of the type and model of the vehicle in which they are installed.

(2) When there are multiple different vehicle data corresponding to the insufficient data, the insufficient data can be appropriately supplemented by supplementing the insufficient data with the different vehicle data obtained in an environment closest to the environment of the first vehicle 10.

(3) When there are multiple different vehicle data corresponding to the insufficient data, the insufficient data can be appropriately supplemented by using statistical values obtained by statistically processing the multiple different vehicle data.

(4) The first ECU 100 can acquire the different vehicle data from the server device 500, the fourth vehicle 40, and the fifth vehicle 50 via network communication.

(5) The first ECU 100 can acquire the different vehicle data from the second vehicle 20 and the third vehicle 30 via vehicle-to-vehicle communication. The vehicle-to-vehicle communication is a higher-rate communication than network communication.

Accordingly, when multiple vehicles are traveling in the platooning manner, the following vehicles can acquire the different data from the leading vehicle at a high rate.

(6) By using the input data manually entered by the user via the first information terminal 65 or the second information terminal 60, the insufficient data can be supplemented even when the first ECU 100 cannot perform network communication or vehicle-to-vehicle communication or when the different vehicle data does not exist. (Other embodiments)

Although the embodiment of the present disclosure has been described above, the present disclosure is not limited to the embodiment described above, and various modifications can be made to implement the present disclosure.

(a) In the above-described embodiment, the second ECU 200 is an ECU separate from the first ECU 100. However, the second ECU 200 may be an ECU that is integrated with the first ECU 100. That is, the central ECU may be provided with the communication unit 130 for communication with the outside of the vehicle.

(b) In the above-described embodiment, the first ECU 100 and the second ECU 200 execute the process of supplementing the insufficient data. However, the server device 500 may execute the process of supplementing the insufficient data. That is, the vehicle data collected by the second ECU 200 of each vehicle may be uploaded to the server device 500. The server device 500 may standardize the uploaded vehicle data to generate the standard data, detect data that is insufficient in response to a request from the application execution unit, and supplement the insufficient data using the different vehicle data.

(c) The controller 110 and method described in the present disclosure may be implemented by a dedicated computer which is configured with a memory and a processor programmed to execute one or more particular functions embodied in computer programs of the memory. Alternatively, the controller 110 and the method described in the present disclosure may be implemented by a dedicated computer provided by forming a processor with one or more dedicated hardware logic circuits. Alternatively, the controller 110 and the method described in the present disclosure may be implemented by one or more dedicated computers including a combination of a processor and a memory programmed to execute one or multiple functions and a processor including one or more hardware logic circuits. The computer program may be stored in a computer-readable non-transitory tangible storage medium as instructions to be executed by a computer. The method for implementing the functions of each unit included in the controller 110 does not necessarily need to include software, and all the functions may be implemented using one or a plurality of hardware circuits.

The multiple functions of one component in the above embodiment may be implemented by multiple components, or a function of one component may be implemented by multiple components. In addition, multiple functions of multiple components may be implemented by one component, or a single function implemented by multiple components may be implemented by one component. Part of the configuration of the above embodiment may be omitted. Further, at least part of the configuration of the above-described embodiments may be added to or replaced with the configuration of another embodiment described above.

(e) In addition to the data management device described above, various features such as a system having the data management device as a component, a program for causing the computer to function as the data management device, a non-transitory tangible storage medium such as a semiconductor memory in which the program is stored, and a data management method may provide to implement the present disclosure.

What is claimed is:

1. A data management device for a vehicle, the device comprising:
a request reception unit configured to receive a data request from an application execution unit configured to execute an application program;
a data collection unit configured to
collect vehicle data transmitted from at least one device mounted on the vehicle, and
by normalizing the collected vehicle data to represent a same physical quantity in a same unit regardless of a vehicle type and a vehicle model, generate standard data;
an insufficiency detection unit configured to compare the data request received by the request reception unit with the standard data generated by the data collection unit to detect insufficient data that is insufficient from the data request; and
a supplement unit configured to supplement the insufficient data detected by the insufficiency detection unit using different vehicle data that is the standard data of at least one different vehicle different from the vehicle.

2. The data management device according to claim 1, wherein
the different vehicle includes a plurality of different vehicles, and
the supplement unit is configured to supplement the insufficient data with the different vehicle data of, among the plurality of different vehicles, a different vehicle that has an environment closest to an environment of the vehicle.

3. The data management device according to claim 1, wherein the different vehicle includes a plurality of different vehicles, and
the supplement unit is configured to supplement the insufficient data with a statistical value calculated by statistically processing the different vehicle data of the plurality of different vehicles.

4. The data management device according to claim 1, wherein
the supplement unit is configured to acquire the different vehicle data from the at least one different vehicle or a database of a server device via network communication.

5. The data management device according to claim 1, wherein
the supplement unit is configured to acquire the different vehicle data from the at least one different vehicle via vehicle-to-vehicle communication.

6. The data management device according to claim 1, wherein
the supplement unit is further configured to acquire input data that is input in response to a manual operation by a user, and supplement the insufficient data with the acquired input data.

7. The data management device according to claim 1, further comprising
a storage configured to store a supplement policy in which a supplement means for supplementing the insufficient data is described,
wherein
the supplement unit is configured to supplement the insufficient data based on the supplement policy stored in the storage.

8. The data management device according to claim 7, wherein
the supplement policy specifies:
(i) a method for selecting and calculating supplement data when there are a plurality of candidates for the supplement data that supplements the insufficient data, and/or
(ii) a means for acquiring the different vehicle data when communication is possible, and/or
(iii) a substitute means when the communication is not possible.

9. A data management method executed by a processing device, the method comprising:
receiving a data request from an application execution unit configured to execute an application program;
collecting vehicle data transmitted from at least one device mounted on a vehicle;
by normalizing the collected vehicle data to represent a same physical quantity in a same unit regardless of a vehicle type and a vehicle model, generating standard data;
comparing the received data request with the generated standard data to detect data that is insufficient for the data request; and
supplementing the insufficient data using different vehicle data that is the standard data of at least one different vehicle different from the vehicle.

10. A non-transitory tangible storage medium storing a data management program causing
a processing device to:
receive a data request from an application execution unit configured to execute an application program;
collect vehicle data transmitted from at least one device mounted on the vehicle;
by normalizing the collected vehicle data to represent a same physical quantity in a same unit regardless of a vehicle type and a vehicle model, generate standard data;
compare the received data request with the generated standard data to detect data that is insufficient for the data request; and
supplement the insufficient data using different vehicle data that is the standard data of at least one different vehicle different from the vehicle.

11. A data management system for a vehicle, the system comprising:
an electronic control unit mounted on a vehicle; and
a server device,
wherein
the server device includes:
a server storage configured to store standard data obtained by normalizing a plurality of vehicle data received from each vehicle to represent a same physical quantity in a same unit regardless of a vehicle type and a vehicle model;
a server controller configured to select the standard data from the server storage; and
a server communication unit configured to communicate with the vehicle and transmit the standard data selected by the server controller to the vehicle, and
the electronic control unit includes:
a request reception unit configured to receive a data request from an application execution unit configured to execute an application program;
a data collection unit configured to
collect vehicle data transmitted from at least one device mounted on the vehicle, and
by normalizing the collected vehicle data to represent the same physical quantity in the same unit regardless of the vehicle type and the vehicle model, generate standard data;
an insufficiency detection unit configured to compare the data request received by the request reception unit with the standard data generated by the data collection unit to detect insufficient data that is insufficient from the data request;
a vehicle communication unit configured to receive different vehicle data that is the standard data of at least one different vehicle different from the vehicle, and is transmitted from the server communication unit; and
a supplement unit configured to supplement the insufficient data detected by the insufficiency detection unit using the different vehicle data received by the vehicle communication unit.

12. The data management system according to claim 11, wherein
the server controller is configured to select, from the standard data stored in the server storage, standard data obtained by normalizing data of, among a plurality of different vehicles, a different vehicle that has an environment closest to an environment of the vehicle, and
the server communication unit is configured to transmit the standard data selected by the server controller to the vehicle.
